(19) United States
(12) Patent Application Publication
(10) Pub. No.: US 2006/0185208 A1
(43) Pub. Date: Aug. 24, 2006

(54) Attaching tool of display tag or the like

(76) Inventors: Mikio Kubota, Tokyo (JP); Tadashi Suzuki, Saitama (JP); Tetsuro Wada, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/534,490

(22) PCT Filed: Dec. 4, 2003
(86) PCT No.: PCT/JP03/15527

§ 371 Date: May 11, 2005

(30) Foreign Application Priority Data
Dec. 4, 2002 (JP) 2002352935

(51) Int. Cl. G09F 3/08

(52) U.S. Cl. 40/662

(57) ABSTRACT

An attaching tool of a display tag or the like, having a coated fiber which has a plastic outer skin formed on the circumference of the core yarn material which is a soft magnetic fiber reacting on magnetism or a composite yarn consisting of the soft magnetic fiber and a fiber having a composition different from the soft magnetic fiber, a first member fixed to one end of the coated fiber, and a second member fixed to the other end of the same.

### TECHNICAL FIELD

The present invention relates to an attaching tool of a display tag or the like having a magnetic body for marker for preventing goods in store fronts or equipment in public facilities from being carried away without notice.

### RELATED ART

A remote-sensing burglarproof system for preventing goods in store fronts or equipment in public facilities from being carried away without notice has been used so far by using a magnetic reaction characteristic to an alternating magnetic field of a soft magnetic body and thereby providing with a magnetic body for marker such as an adhesive bar code, a tag for price or quality display, or a band plate for goods and the like, and setting a sensing gate for generating an alternating magnetic field at an exit.

The sensing system using magnetism uses a magnetic body for marker made of a soft magnetic material such as an amorphous metallic material having high magnetic permeability and that can easily be magnetized or demagnetized, which generates an alternating magnetic field by using a magnetic field application coil at the sensing gate side and which generates a voltage pulse in a detection coil (pickup coil) at the sensing-gate side in accordance with the Barkhausen effect that occurs when reversing the magnetization of the magnetic body for marker entering the alternating magnetic field, and detects the presence or absence of the magnetic body for marker through a non-contact and remote way by detecting the above voltage pulse (refer to Japanese patent application Kokai publication No. 1994-119565).

Moreover, in the case of this sensing system, even if a customer passes through the normal route such as the cash register of a store to which the magnetic body for marker is set, an alarm is set off when passing through a similar sensing system in a different store which is able to sense the magnetic body for marker. Because this may be inconvenient, a semi-hard magnetic material is added for the magnetic body for marker made of the soft magnetic material in order to “inactivate” the magnetic body for marker not to be sensed by the sensing system and thereby prevent the alarm from being set off.

The semi-hard magnetic material is a magnetic material having a proper-size angular hysteresis loop without magnetic holding power as great as permanent magnetic material. When the semi-hard magnetic material is not magnetized, the magnetic body for marker of the soft magnetic material shows the Barkhousen effect by an alternating magnetic field and is sensed by the sensing system. However, when magnetizing the semi-hard magnetic material applied with a strong magnetic field, the material cannot be sensed because the magnetic force of the semi-hard magnetic material interrupts the alternating magnetic field of the sensing system. Therefore, when passing through the normal route such as a cash register, it is possible to magnetize the semi-hard magnetic material and inactivate the magnetic body for marker.

In the case of the invention disclosed in the above Patent Document, a dry paint film made by a magnetic paint in which soft magnetic powder is dispersed together with bonding agent is used as a magnetism detection marker. Therefore, the dry paint film is suited to use by printing it on a burglarproof label. However, it is impossible to use the film by forming it into a filament or to apply the film for the magnetism detection marker using the filament material as a raw material. Moreover, when applying the material of the above to the surface of a filament, it is difficult to process it and the material of the above invention cannot be realized as goods due to its cost and appearance.

A magnetic body for marker is formed into a filament and set to the back of bar-code sheet or tag. In this case, there are problems that the magnetic body for marker is easily removed and it is functional for only a short period of time.

Moreover, a stamp-shaped small seal to whose back the magnetic body for marker is set is easily found due to its appearance. Therefore, it is possible to easily recognize the burglarproof tool because of the limited concealing characteristic.

Furthermore, when a person discovers that a magnetic body for marker is attached, there is a problem that the body is removed or broken, and it is impossible to sufficiently exercise the burglarproof function.

For this reason, to prevent the theft of goods in a store front, it is important to place the magnetic body for marker in a product in a way which conceals the presence of the body and in a manner in which the body cannot be discovered with just a mere glance.

Therefore, the present inventor et al. has developed a security yarn having a soft magnetic fiber and its manufacturing method to solve the above problems and proposes them as Japanese patent application No. 1999-195919.

The present inventor et al. manufactured an annular connecting tool (a connecting tool same as that sold as the trade name LOCKS) in which an engaging male portion is formed at one end of a yarn-like connecting portion formed by a plastic extension filament and an engaging female portion is formed at the other end of the yarn-like connecting portion in order to set a display tag for displaying the price and quality on clothing and the like displayed in a store front.

This is made by passing the engaging male portion through the through-hole of a display tag or the like and the setting hole of a button hole or the like formed on the cloth of the clothing, and then engaging the engaging male portion with the engaging female portion, forming the loop of the yarn-like connecting portion, and setting the display tag to goods.

Moreover, as a result of studying whether a soft magnetic fiber can be used for a filament of a label attaching tool (tag pin) having a head portion at one end of the filament and a crossbar portion at the other end of the same, the present inventor et al. confirmed that the fiber could be used in almost all situations.

[Structure of Soft Magnetic Fiber]

The yarn-like body described in the specification of the above Japanese patent application No. 1999-195919 is formed like a twisted yarn in appearance by winding a cover material such as a narrow cloth or yarn on the circumference of a core material made of a magnetic fiber or core yarn to coat it and the soft magnetic fiber is a soft coated yarn coated with the cover material.

Therefore, the soft magnetic fiber has an advantage that it does not directly contact a finger tip or goods because it is protected by the cover material, thus preventing the finger tip or the like from being damaged.

However, because the cover material is formed by a twisting frame in a yarn twisting process, there are problems that the manufacturing process becomes complex and the manufacturing cost increases because the twisting speed is not as fast as the spinning speed.

Moreover, the cover material has a hygroscopic property and is easily contaminated, depending on its quality. Furthermore, there is a disadvantage that when a part of the cover material is broken, the cover material is scattered and its appearance becomes unattractive.

Particularly, in the case of the yarn-like body according to the above invention, it is necessary to coat the soft magnetic fiber with the cover material in a twisting process. Therefore, even if only the soft magnetic fiber is used to decrease the cost, manufacturing is difficult considering its structure because the soft magnetic fiber is not very strong.

### DISCLOSURE OF THE INVENTION

The first object of the present invention is to provide an attaching tool of a display tag or the like using a yarn-like body (filament) constituted by a magnetic body for marker eliminating a defect of a developed yarn-like body, that is, a defect due to the fact that the manufacturing cost is high and a cover material is exposed, as the main material.

Furthermore, an object of the present invention is to provide a conventional attaching tool, that is, a connecting tool in which an engaging male portion is formed at one end of a yarn-like body and an engaging female portion is formed at the other end of the same that are annularly connected, moreover to provide the so-called tag pin in which a flat head portion is formed at one end of the yarn-like body and a crossbar portion is formed at the other end of the same.

The present invention is made to solve the problem that the above-described attachment-type burglarproof tool is weak in concealing characteristic and constituted as described below.

1) It is characterized in that a soft magnetic fiber reacting on magnetism or a composite yarn consisting of the soft magnetic fiber and a fiber having a composition different from the soft magnetic fiber is used as a core yarn material, a coated fiber has a plastic outer skin formed on the circumference of the core yarn material, a first member is fixed to one end of the coated fiber, and a second member is fixed to the other end of the same.

2) It is characterized in that a composite yarn consisting of a soft magnetic fiber reacting on magnetism, a semi-hard magnetic fiber for inactivating a reaction on magnetism, and a reinforcement material is used as a core yarn material, a coated fiber is made by forming a plastic outer skin on the circumference of the core yarn material, and a first member fixed to one end of the coated fiber and a second member fixed to the other end of the same are fixed each other.

3) It is characterized in that a soft magnetic fiber reacting on magnetism or a composite yarn consisting of the soft magnetic fiber reacting on magnetism and a fiber having a composition different from the soft magnetic fiber is used as a core yarn material, a coated fiber is made by forming a plastic outer skin on the circumference of the core yarn material, a first member is fixed to one end of the coated fiber, a second member is fixed to the other end of the same, the first member is a thin-plate head portion, and the second member is a short crossbar portion.

4) It is characterized in that a soft magnetic fiber reacting on magnetism or a composite yarn consisting of the soft magnetic fiber and a fiber having a composition different from the soft magnetic fiber is used as a core yarn material, a coated fiber is made by forming a plastic outer skin on the circumference of the core yarn material, a first member is fixed to one end of the coated fiber, a second member is fixed to the other end of the same, the first member is a thin-plate head portion, the second member is a short crossbar portion, and the core yarn material is extended in the crossbar portion.

5) It is characterized in that a soft magnetic fiber reacting on magnetism or a composite yarn consisting of the soft magnetic fiber and a fiber having a composition different from the soft magnetic fiber is used as a core yarn material, a coated fiber is made by forming a plastic outer skin on the circumference of the core yarn material, a first member is fixed to one end of the coated fiber, a second member is fixed to the other end of the same, the first member is a thin-plate head portion, the second member is a short crossbar portion, a filament is extended which directs from the center of the crossbar portion to the head portion, an expanded portion is formed on the filament portion, and the coated fiber extended from the head portion side is embedded in the expanded portion.

6) It is characterized in that a soft magnetic fiber reacting on magnetism or a composite yarn consisting of the soft magnetic fiber and a fiber having a composition different from the soft magnetic fiber is used as a core yarn material, a coated fiber is made by forming a plastic outer skin on the circumference of the core yarn material, a first member is fixed to one end of the coated fiber, a second member is fixed to the other end of the same, the first member is formed into an engaging male portion, the second member is formed into an engaging female portion in which an insertion hole is opened, and the engaging male portion is inserted into the insertion hole of the engaging female portion so that the male portion can be engaged like a ring so as not to be removed.

7) It is characterized in that an aggregate of attaching tools of display tag arranging in parallel a plurality of attaching tools of display tags or the like is formed into one flat plate as a whole, by using a soft magnetic fiber reacting on magnetism or a composite yarn consisting of the soft magnetic fiber and a fiber having a composition different from the soft magnetic fiber as a core yarn material, including a coated fiber made by forming a plastic outer skin on the circumference of the core yarn material, fixing a first member to one end of the coated fiber and a second member to the other end of the same respectively, providing with an engaging male portion as the first member and an engaging female portion in which an insertion hole is opened as the second member, inserting the engaging male portion into the insertion hole of the engaging female portion so that the engaging male portion can be engaged like a ring so as not to be removed; wherein the attaching tools of display tags are connected to one connecting rod disposed in the vicinity of the engaging male portion through a connecting portion which is able to be cut, and further connected to one connecting rod disposed in the vicinity of the engaging female portion to be cut.

8) It is characterized in that an aggregate of attaching tools of display tags arranging in parallel a plurality of attaching tools of display tags or the like is formed into one flat plate as a whole, by using a soft magnetic fiber reacting on magnetism or a composite yarn consisting of the soft magnetic fiber and a fiber having a composition different from the soft magnetic fiber as a core yarn material, including a coated fiber made by forming a plastic outer skin on the circumference of the core yarn material, fixing a first member to one end of the coated fiber and a second member to the other end of the same respectively, providing with an engaging male portion as the first member and an engaging female portion in which an insertion hole is opened as the second member, inserting the engaging male portion into the insertion hole of the engaging female portion so that the engaging male portion can be engaged like a ring so as not to be removed; wherein the attaching tools of display tags are connected to one connecting rod through a connecting member which can be cut so as to support the engaging male portion in a state of sleepers to space toward the engaging male portion, and moreover connected to one connecting rod through a connecting member which can be cut so as to support the engaging female portion by spacing toward the engaging female portion.

A coated fiber used in the present invention represents the following.

a) A single soft magnetic fiber or a fiber aggregate (yarn bundle or composite yarn) made by arranging the soft magnetic fiber with glass fiber, synthetic fiber having a high strength, and a reinforcement material such as a reinforcement tape serving as an indispensable component is used as a raw material.

Moreover, a fiber aggregate made by adding a fused yarn to the above fiber aggregate and arranging them is used as a core yarn material serving as a raw material. When the fused yarn is added, a raw material is formed into a bundled-like body or bristle-state core yarn material by heat-treating the raw material at a temperature for melting the fused yarn.

The fiber aggregate represents a straight yarn or a yarn made by twisting and coating the circumference of a soft magnetic fiber with other fiber while keeping the soft magnetic fiber in a straight state. Moreover, the fiber aggregate is made by using the yarn as a core yarn material and coating its circumference with plastic (basic coated fiber).

b) A metallic two ply yarn constituted by metallic fibers made by arranging a soft magnetic fiber and a semi-hard magnetic fiber having a demagnetizing function is used as an indispensable component, and the single metallic two ply yarn, a fiber aggregate made by adding glass fiber, synthetic fiber having a high strength, and a reinforcement material such as a reinforcement tape to the metallic two ply yarn and arranging them, or a fiber aggregate made by adding a fused yarn to the above fiber aggregate and arranging them are used as a raw material.

Moreover, it is possible to use a fiber made by coating the surface of the fiber aggregate with a reinforcement yarn made of glass fiber or the like by twisting as a core yarn material serving as a raw material.

Furthermore, the fiber is made by applying a plastic coat to the circumference of the core yarn material (demagnetizing-function coated fiber).

c) A single soft magnetic fiber or a metallic two ply yarn of the soft magnetic fiber and a semi-hard magnetic fiber having a demagnetizing function is used, a reinforcement material of a glass fiber or the like or a straight fiber aggregate (composite yarn) made by arranging the reinforcement material and a fused yarn is formed on the metallic two ply yarn to form a core yarn material in which the surface of the fiber aggregate is coated with a cover material such as a reinforcement fiber, reinforcement tape, or gold or silver thread by twisting. Then, a coated fiber is realized and the surface of the core yarn material is coated with plastic (coated fiber having cover material).

d) For product using coated fiber

A product using the coated fiber uses the coated fiber as an important component. For example, there is a lock or attaching tool referred to as “tag pin” in which a head portion is set to one side of the coated fiber and a crossbar portion is set to the other side of it. Moreover, there is an attaching tool in which an engaging male portion is formed on one side of the coated fiber and an engaging female portion is formed on the other side of it, so-called “product name: LOCKS”.

Furthermore, there is a stopper in which a stopper such as a safety pin is set to one end of a coated fiber and a display tag like a large hook having two engaging portions is set to the other end of the same. Furthermore, it is needless to say that the present invention can be applied to various attaching tools such as an attaching tool to whose one end V-shaped engaging male and female portions are set and to whose other end a hook-like holding portion is set.

Because this coated fiber is like a nylon string or a hard thick yarn (like a bristle) at a glance, it is possible to apply the coated fiber to magnetism detection means by forming the fiber into a straight-line, coiled, convolutional, or spiral shape.

### BRIEF DESCRIPTION OF THE DRAWINGS

FIG. 1 is an illustration of a coated fiber, used in the present invention, manufacturing process;

FIG. 2 is an illustration of a coated fiber, used in the present invention, manufacturing process;

FIG. 3 is an illustration of a coated fiber, used in the present invention, manufacturing process;

FIGS. 4(A) to 4(F) are illustrations showing various types of coated fibers, in which FIG. 4(A) shows a soft magnetic fiber used as a single yarn, FIG. 4(B) shows a coated fiber constituted by a soft magnetic fiber and a semi-hard magnetic fiber, FIG. 4(C) shows a coated fiber using a soft magnetic fiber, semi-hard magnetic fiber, and a reinforcement fiber, FIG. 4(D) shows a coated fiber using a soft magnetic fiber, semi-hard magnetic fiber, and deposited fiber, and FIGS. 4(E) and 4(F) respectively show a coated fiber made by winding various cover materials on a composite yarn constituted by a soft magnetic fiber, semi-hard magnetic fiber, and deposited fiber and forming a coating layer on the surface of them by plastic;

FIGS. 5(A) and 5(B) are an attaching tool of a tag-pin-type display tag or the like, in which FIG. 5(A) shows a front view and FIG. 5(B) shows a side view;

FIGS. 6(A) and 6(B) show an aggregate of attaching tools of tag-pin-type display tags, in which FIG. 6(A) is a front view and FIG. 6(B) is a side view;

FIG. 7(A) is an illustration of a layout state of fibers of a crossbar portion of a tag-pin-type attaching tool and 7(B) is an illustration of an attaching tool obtained by forming an expansion portion on a filament portion extended from the middle of a crossbar portion and thereby connecting a coated fiber;

FIG. 8 is a perspective view showing a state in which a display tag is set to goods by a tag-pin-type attaching tool;

FIGS. 9(A) and 9(B) show an annular connecting-type attaching tool, in which FIG. 9(A) is a front view and FIG. 9(B) is a side view;

FIG. 10(A) is an illustration of a state in which a display tag is set to goods by an annular connecting-type attaching tool and 10(B) is a sectional view showing a structure of an engaging portion;

FIGS. 11(A) to 11(D) show an annular connecting-type attaching tool, in which FIG. 11(A) is a front view of an attaching tool having an angular fitting hole, FIG. 11(B) is a top view of the attaching tool, FIG. 11(C) is a top view of an attaching tool having a circular fitting hole, and FIG. 11(D) is a front view obtained by cutting out a part of the attaching tool;

FIG. 12(A) is a front view of a flat aggregate made by connecting annular connecting tools by two connecting rods and 12(B) is an X-X sectional view of the aggregate; and

FIG. 13(A) is a front view of an aggregate made by connecting annular connecting tools in a state of sleepers by two connecting rods and 13(B) is a side view of the aggregate.

### DETAILED DESCRIPTION OF THE INVENTION

A manufacturing method of a coated fiber having a built-in soft magnetic fiber and various types of attaching tools including a display tool using the coated fiber of the present invention are described below by referring to the accompanying drawings.

[Soft Magnetic Fiber f]

A nylon-string-like or bristle-like coated fiber constituting an essential portion of an attaching tool of a display tag or the like of the present invention has a built-in soft magnetic fiber reacting on the magnetism generated by a detector of a burglarproof device, and the soft magnetic fiber is made of a magnetic material showing a soft magnetic characteristic which can be easily magnetized or demagnetized.

For example, in the case of an excitation magnetic field in which the intensity of a magnetic field is 0.4 μm (5 m Oe:moersted) and the frequency of an alternate magnetic field is 1 kHz, it is preferable to use a material having a high magnetic permeability of 1,000 or more. Materials showing the high magnetic permeability include permalloy, Fe—Si-based alloy, amorphous metal, and the like.

Particularly, an amorphous metal fiber mainly containing Co—Fe—Si—B shows a high magnetic permeability of 10,000 or more in an excitation magnetic field in which the intensity of a magnetic field is 0.4 A/m (5 mOe) and the frequency of an alternate magnetic field is 1 kHz.

Moreover, because the amorphous metal fiber mainly containing Fe—Co—Si—B has a large Barkhausen effect, it is preferable to use these amorphous metal fibers.

A semi-hard magnetic material for performing demagnetization, deactivation, or inactivation requires a coersive force between approx. 800 A/m [10 Oe (oersted)] and approx. 40,000 A/m (500 Oe) (both included) and various Fe alloys and Co alloys can be used. Above all, Fe—Co—V-based alloy and Fe—Co—Cr-based alloy show a superior semi-hard magnetic characteristic between approx. 2,400 A/m (30 Oe) and approx. 12,000 A/m (150 Oe) (both included), thus being suitable for this application.

By using a metallic material having the above composition, a very thin wire rod (soft magnetic fiber) having a diameter of 0.1 to 0.2 mm is manufactured in a wire drawing process.

The above soft magnetic fiber and semi-hard magnetic fiber are restricted in length which can be detected by a magnetism detector and therefore, a very short fiber does not function. Specifically, a fiber having a length of 5 to 6 cm or more is necessary and when actually using a fiber, a fiber having the above length is adopted.

[Manufacturing of Coated Fiber F]

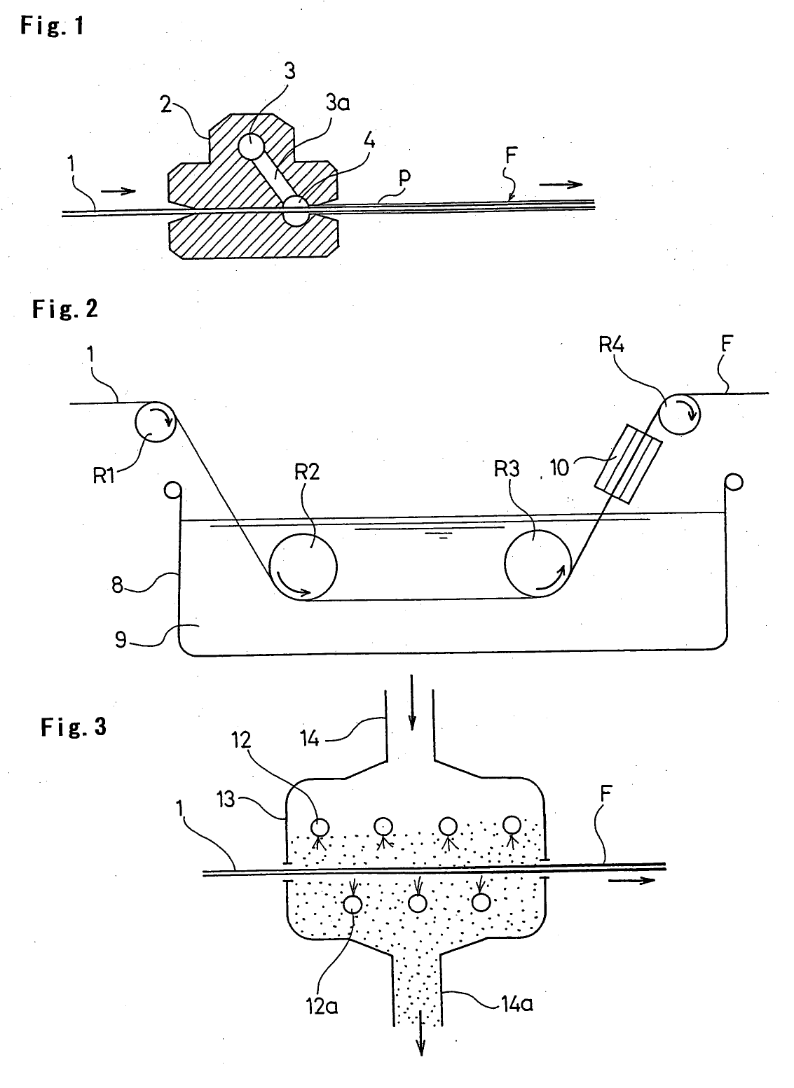

FIG. 1 shows an extrusion coating process of a soft magnetic fiber. A core yarn material (core wire) 1 including the soft magnetic fiber f is inserted into the guide hole of die 2 at a predetermined speed. When using clothing fiber such as 66 nylon, polyester, or polypropylene as plastic for forming a coating layer of the fiber formed on the die 2, a thermoplastic plastic having a sufficient strength is used.

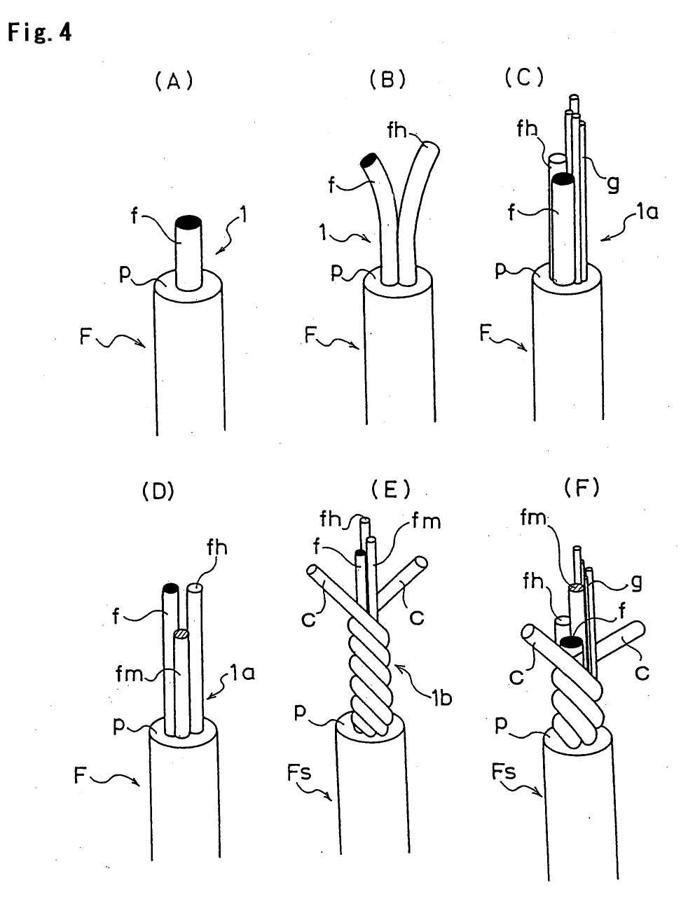

A coated fiber F is formed by melting the thermoplastic plastic by an extruder, supplying the plastic from the supply hole 3 of the die 2, supplying the plastic to a coat hole 4 through a guide hole 3a, and forming a plastic coating layer p around the core yarn material 1 using the soft magnetic fiber f moving in the coat hole 4 as a component material or central material (refer to FIG. 4).

The soft magnetic fiber f which is an indispensable component of the core yarn material 1 forming the coated fiber F normally uses a thin metallic wire having a diameter of approx. 0.1 mm. A very fine metallic wire having a low strength is frequently used. Therefore, the wire is normally used by arranging it and a reinforcement material such as a glass fiber because it is difficult to directly use the wire. Moreover, though the manufacturing cost slightly increases, the wire is used by twisting a reinforcement fiber, tape, or the like while straightly holding a soft magnetic fiber, forming the whole into a yarn, and providing a strength.

[Yarn-Like Body to be Deactivated or Inactivated]

To provide both functions of a magnetization function and demagnetization function, it is preferable to use the soft magnetic fiber f and a semi-hard magnetic fiber together and moreover, form the core yarn wire 1 by adding a reinforcement material such as a glass fiber or tape and providing a sufficient strength.

Moreover, though the outside diameter of the coated fiber F ranges between 0.4 and 0.5 mm, this outside diameter is equal to that of a filament used for an attaching tool normally sold (tag pin or trade name: LOCKS). It is preferable to use a setting unit (such as gun) used to set the attaching tool, so that a display tag can be fixed to goods such as clothes, or a plurality of goods such as a pair of house shoes can be gathered, in the same way as the normal attaching tool.

In the case of a coating process of plastic onto the core material surface, it is possible to efficiently perform manufacturing at a considerable high speed like a process of as if manufacturing a thin enamel wire, as described below.

FIG. 2 shows a dip coating process of soft magnetic fiber f, in which the surface of the fiber f is coated while heating and melting a plastic material such as 66 nylon into a melted solution 9 in a vessel 8 in an inactive atmosphere at a predetermined temperature, guiding the core yarn material 1 containing the fiber to a predetermined path through guide rollers R1, R2, R3, R4, . . . and dipping the material 1 in the melted solution 9. Then, the coated fiber F immediately after coated is cooled by air-cooling in a cooler 10 and then, wound in a not-illustrated winding process. FIG. 3 shows a process of spraying the heated and melted plastic on the core yarn material 1 including a soft magnetic fiber at a high pressure to coat the fiber. The core yarn material 1 is inserted into a treatment chamber 13 in which many nozzles 12 and 12a are arranged to coat it. Moreover, in the inside of the treatment chamber 13, air supply and air exhaust at a predetermined temperature are performed by a duct 14 and 14a and the atmosphere is adjusted to a state suitable for coating.

Then, the coated fiber F is manufactured by inserting the core yarn material 1 including the soft magnetic fiber f from the entrance of the treatment chamber 13, spraying the plastic melted while moving it at a high pressure, coating the circumference of the core yarn material 1 with plastic at a predetermined thickness, and cooling the core yarn material 1 and the plastic by a not-illustrated cooler.

FIG. 4 shows a structure of the coated fiber F manufactured by the coating process described in the above FIGS. 1 to 3.

FIG. 4(A) shows a basic coated fiber F made by forming a coating layer p of plastic (such as 66 nylon) around a slightly-thick soft magnetic fiber f. FIG. 4(B) shows a coated fiber F having an “inactivation function” obtained by forming a plastic coating layer p on the core yarn material 1 constituted by the soft magnetic fiber f and a semi-hard magnetic fiber fh.

Moreover, FIG. 4(C) shows a coated fiber F made by forming a plastic coating layer p around a core material 1a of a yarn-like body constituted by the soft magnetic fiber f, semi-hard magnetic fiber fh, and a reinforcement material such as a glass fiber g added as reinforcement.

Furthermore, FIG. 4(D) shows a coated fiber F made by forming the plastic coating layer p on the core yarn material 1a constituted by a composite yarn consisting of the soft magnetic fiber f, semi-hard magnetic fiber fh, and a thermal fused yarn fm.

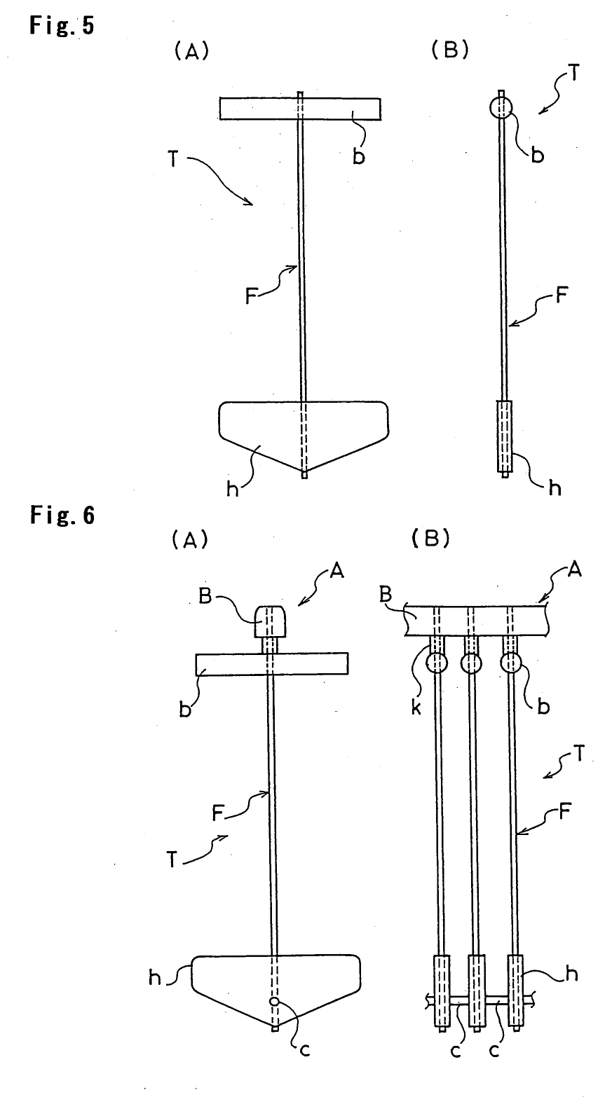

FIGS. 5(E) and 5(F) are a coated fiber Fs manufactured by using the twisted-yarn-type soft magnetic fiber disclosed in the above Japanese patent application No. 1999-195919 as a core yarn material 1b and applying the coating treatment of the present invention to the core yarn material 1b.

FIG. 4(E) is a fiber using a core yarn material 1b made by coating a yarn (composite yarn) constituted by the soft magnetic fiber f and the thermal fused yarn fm with a cover material C constituted by a cloth tape or flat yarn. The core yarn material 1b is formed into a coated fiber Fs having a plastic coating layer p around the core yarn material 1b by using the coating treatment apparatus shown in FIGS. 1 to 3.

The coated fiber Fs having the above structure conceals the presence of a magnetic body for marker, that is, the soft magnetic fiber f coated by the cover material C and prevents a finger tip or goods from being damaged when the soft magnetic fiber f is exposed.

FIG. 4(F) shows a coated fiber Fs having a structure almost same as that in FIG. 4(E). The coated fiber Fs is formed by arranging the soft magnetic fiber f, thermal fused yarn fm, and the tape-like or yarn-like reinforcement material g into a straight object, twisting it with the cover material C and coating it, and then forming the coating layer p with melted plastic on the circumferential face of the straight object.

In the case of an attaching tool using the coated fibers F and Fs shown in FIGS. 4B to 4F, the semi-hard magnetic fiber fh is included in the soft magnetic fiber f and the circumference of the fiber f is coated with the plastic coating layer p. Therefore, when passing through a normal route such as a cash register, the semi-hard magnetic fiber fh is magnetized by making it pass through the magnetic field of a permanent magnet or the like to inactivate the soft magnetic fiber f, and it is possible to set the fiber f so that the fiber f cannot be sensed by a sensing system.

By arranging the thermal fused yarn fm along the soft magnetic fiber f and coating the whole with the cover material C and then drying and thermally treating the coat C, the thermal fused yarn fm is deposited and the soft magnetic fiber f and the reinforcement material g are integrated by the cover material C, the core yarn materials 1, 1a, and 1b for preventing the soft magnetic fiber f from being removed and exposed are used, and moreover the strength of the plastic such as 66 nylon is improved by the circumferential coating layer p to form like a plastic filament or bristle as a whole.

It is preferable that a yarn-like reinforcement material for reinforcing the soft magnetic fiber f is thicker than the soft magnetic fiber f. Moreover, it is possible to use a bundled filament constituted by various types of plastic fibers or natural fibers, twisted filament, thermal fused yarn, staple fiber, rayon fiber having a low elastic modulus, and the like for the reinforcement material. Moreover, the thermal fused yarn fm uses a plastic material having a thickness of 100 to 200 d (denier) and low-melting-point plastic having a deposition temperature of approx. 100° C.

Moreover, the cover material C coats the circumference of the soft magnetic fiber f, reinforcement material g, semi-hard magnetic fiber fh, and thermal fused yarn fm and has a function for mechanically and visually protecting them, which can use a yarn or tape-like object using synthetic fiber such as nylon or polyester or natural fiber.

Furthermore, the cover material C can also use a gold thread or silver thread constituted by various materials. When the gold thread or silver thread is used as an example, it is particularly preferable to use a macromolecular film made of polyester or the like on whose one side aluminum is vacuum-deposited, or use the cover material C formed into a metallic state by coloring it with an optional color such as blue, red, or green. It is possible to use these colors not only for decoration effect but also to identify the size, type, or material quality of goods.

Furthermore, it is allowed to wind the reinforcement material g such as a glass fiber arranged together with the soft magnetic fiber f or soft magnetic fiber f serving as a core on one type of the cover material C like a single spiral, alternately wind two types of the cover materials C like a double spiral with no gap, or use three gold threads or silver threads and thereby crossing these gold or silver threads diagonally, back and forth, or vertically, fastening them through knocking, forming them into a braiding structure, and coating them with a cover material.

### First Embodiment, Tag Pin

FIG. 5 shows a “tag pin T” of the first embodiment of the present invention serving as an attaching tool of a display tag or the like, in which a flat-plate head portion h is fixed to one end of a coated fiber F of the present invention and a short crossbar portion b is fixed to the other end of the same during molding process. The tag pin is constituted by integrally fixing the head portion h and the crossbar portion b simultaneously with molding in the insert molding process in which the coated fiber F is set in a mold.

To manufacture the tag pin T, many coated fibers F are arranged in a mold in parallel, and the head portion h and the crossbar portion b are simultaneously molded while the coated fibers F are interposed at the center of the head portion h and the crossbar portion b that are separated from each other at a predetermined interval (refer to FIG. 6). Then, a lot of tag pins T are continuously manufactured by intermittently moving the coated fibers F by predetermined distance.

One hundred to two hundred tag pins T are normally manufactured as an aggregate, mounted on a setting unit, and knocked in one by one.

A case of manufacturing the aggregate A of the tag pins T is described below. As shown in FIG. 6, many tag pins T in which the head portion h and the crossbar portion b are arranged at predetermined intervals by using the coated fiber F as a central member are arranged in parallel and insert-molded. In this case, two head portions h are connected by a thin filament-like connecting portion c so that they can be cut.

Then, a connecting rod B is molded nearby the crossbar portion b while making the coated fiber F penetrate. The connecting rod B and the crossbar portion b are connected by a connecting portion k which can be cut by a cutter of the setting unit while knocking the tag pins in.

The aggregate A can hammer out the tag pins T one by one while inserting the connecting rod B into the mounting hole of the setting unit as publicly known.

The coated fibers F constituting the tag pins T are integrally molded so as to be orthogonal to the crossbar portion b {FIG. 5(A)}. However, because the crossbar portion b has a diameter of 0.6 to 1.0 mm, the bonding strength decreases when the coated fiber F is only fixed to the crossbar portion b.

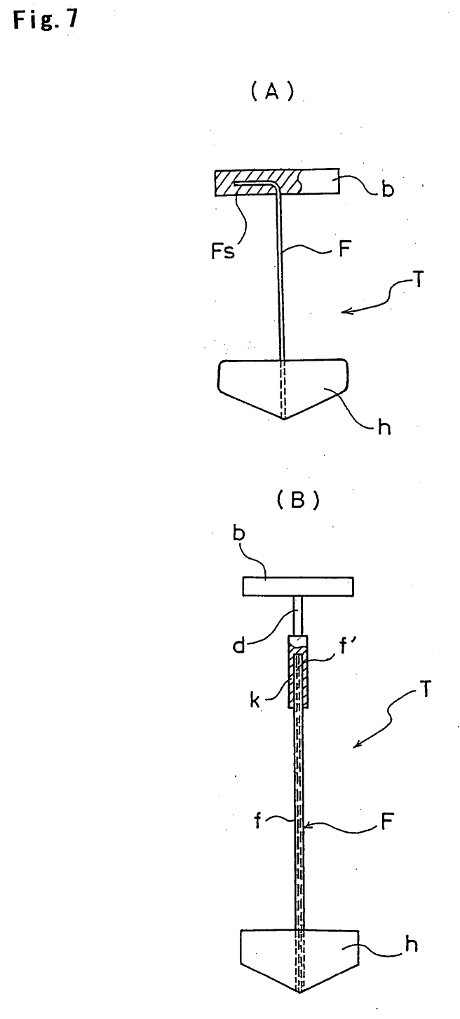

Therefore, as shown in FIG. 7(A), the front end Fs of the coated fiber F is cut while it is dragged up to the middle portion of the cavity that molds the crossbar portion b and then, the crossbar portion b is molded in a process of injecting resin. The length of the front end Fs of the coated fiber F embedded in the crossbar portion b is approx. half the crossbar portion b and it is preferable to form the front end Fs like an L shape to the straight line portion. Though a continuous molding method for molding the front end Fs while embedding the coated fiber F in the crossbar portion b is disclosed in a separate patent application, the method is not described here.

Moreover, when embedding the coated fiber F in the crossbar portion b as shown in FIG. 7(A), a very accurate molding is necessary because the diameter of the crossbar portion b is very thin such as approx. 0.8 mm. Therefore, to simplify embedding of the coated fiber F, it is preferable to adopt a structure in which a filament portion d and an expanded portion k are integrally molded on the crossbar portion b and thereby, the coated fiber F is fixed so as to embed its front end f′ in the expanded portion k, as shown in FIG. 7 (B).

Because the length of the expanded portion k can be optionally selected, it is possible to adjust the bonding strength between the filament portion d and the coated fiber F.

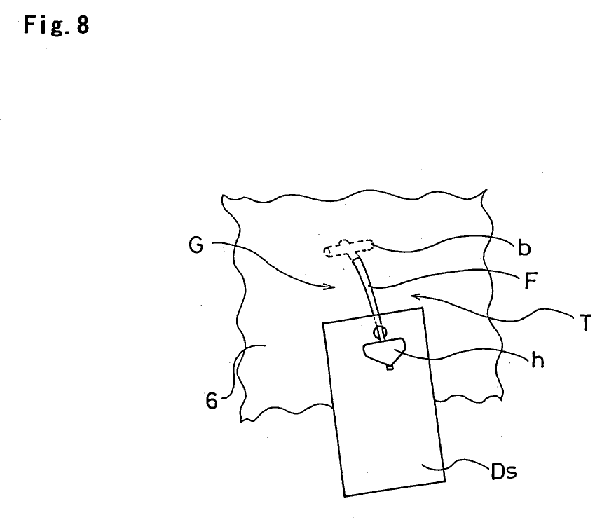

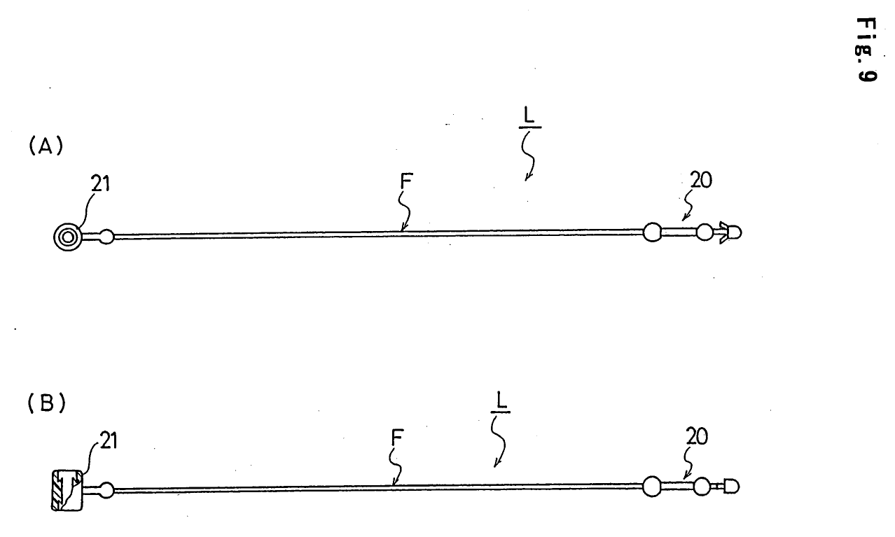

In the case of the tag pin T, as shown in FIG. 8, a display tag Ds can be set by using a publicly-known setting unit (tag gun), thereby making the crossbar portion b and a part of the coated fiber F penetrate the goods G such as clothes and locating the crossbar portion b at the back.

### Second Embodiment: Annular Connecting Body L

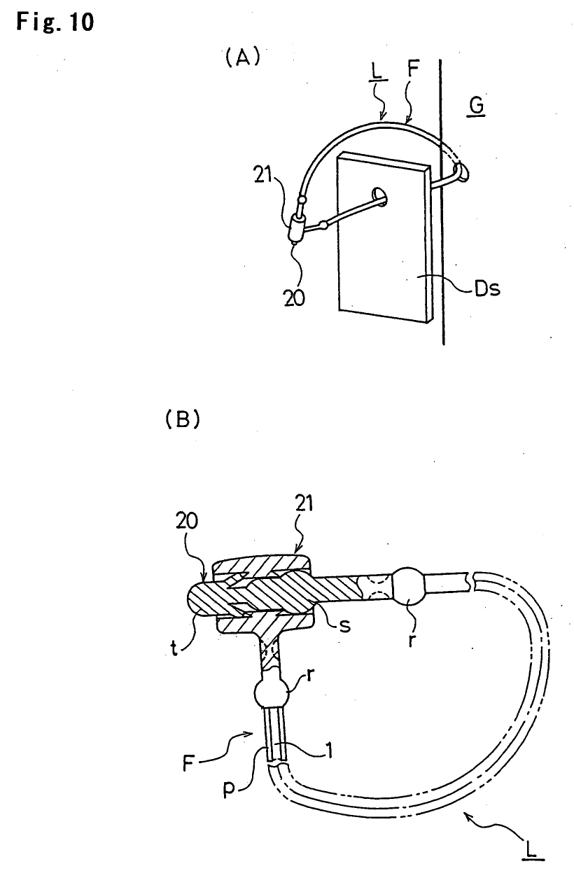

FIGS. 10(A) and 10(B) show an “annular connecting body L (trade name: LOCKS) as an attaching tool of a display tag Ds of the second embodiment of the present invention, which show a connecting body using the coated fiber F made by setting a plastic coating layer p (refer to FIG. 4) on the surface of a core material 1 using a yarn-like body including a magnetic body for marker, that is, a soft magnetic fiber f.

The annular connecting body L serving as an attaching tool of a display tag or the like has an engaging male portion 20 on which plastic such as nylon is molded at one end of the coated fiber F and an engaging female portion 21 at the other end of the same, which is constituted so as to connect the coated fiber F like a ring by inserting the engaging male portion 20 into the hole of the engaging female portion 21 and engaging the engaging male portion 20 with an annular protrusion (refer to FIG. 10) formed in the hole.

When using the coated fiber F as a constituting material of the annular connecting body L, it is necessary to realize a connecting structure in which the coated fiber F, the engaging male portion 20, and the engaging female portion 21 can be firmly fixed by insert molding as described above.

The engaging male portion 20 and the engaging female portion 21 of the annular connecting body L are fitted to each other to form a loop as shown in FIG. 10(A) to make it possible to set the display tag Ds to the goods G such as clothes.

The engaging male portion 20 and the engaging female portion 21 are molded into a structure {FIG. 10(B)} and dimensions having a tensile strength at which they are not easily removed when they are carried, packaged, or moved or they are not easily broken by manual operations after the display tag Ds is once set to the goods G such as clothes, and they are formed so that the trace is left when they are cut or broken.

An example of the coated fiber F shown in FIG. 4 to be used for this embodiment is described below.

The soft magnetic fiber f is formed by a CO—Fe—Si—B-based amorphous fiber having a diameter 100 μm, showing a high magnetic permeability of 5,000 or more and spirally coated as two cover materials C of polyethylene terephthalate yarns of 1,000 d (denier) together with the thermal fused yarn fm of 200 d (denier), reinforcement material g constituted by a bundled filament of nylon of 200 d (denier), and Fe—Co—V-based demagnetized semi-hard magnetic fiber fh having a diameter 80 μm, having a coercive force of 550 A/m (1,200 Oe) so as to be used as the raw material of the core material 1 and thereafter, dried and thermally-treated at 120° C. for 30 min to form the core yarn material 1 including a yarn-like magnetic body for marker.

Then, a coating layer of 66 nylon p is formed on the surface of the yarn-like core yarn material 1 by using the coating unit shown in FIGS. 1 to 3 to complete the coated fiber F.

FIG. 10(B) shows an example of the engaging portion of the annular attaching tool L of a display tag, in which the engaging male portion 20 formed at one end of the coated fiber F and the engaging female portion 21 formed at the other end of the same are formed by including the engaging male portion 20 capable of passing through the inside diameter of an annular protrusion formed in the through-hole of the engaging female portion 21, an elastically expandable engaging wing extended to the rear of the engaging male portion 20, and a stopper portion set to the rear of the engaging wing and expanded than the annular protrusion.

The engaging male portion 20 has a head portion t, a stopper portion s, and a spherically-expanded connecting portion r and moreover, the same connecting portion r is formed at the engaging female portion 21 side to join the coated fiber F by the connecting portion r.

The engaging strength between the engaging male portion 20 and the engaging female portion 21 is set so that a display tag DP or the like is not easily removed and replaced or engagement cannot be realized again because the engaging make portion 20 or engaging female portion 21 is broken when canceling engagement by forcedly pulling the portions 20 and 21 after once engaged. Generally, the strength engaging the engaging fame portion 21 with the engaging female portion 20 is approx. 6-7 kg at which the portions 20 and 21 cannot be disconnected by manually pulling them.

Moreover, as shown in FIG. 10(B), a broken portion having an engaging strength smaller than the engaging strength between the obtained by decreasing the cross section may be formed on the connecting portion between the engaging portion 21 between the engaging male portion 20 and the coated fiber F on one side and the coated fiber F on the other as shown by a chained line. According to this configuration, it is possible to easily disconnect the engaging male portion 20 or engaging female portion 21 from the coated fiber F by bending or twisting the broken portion and remove the display tag 5 from the goods G.

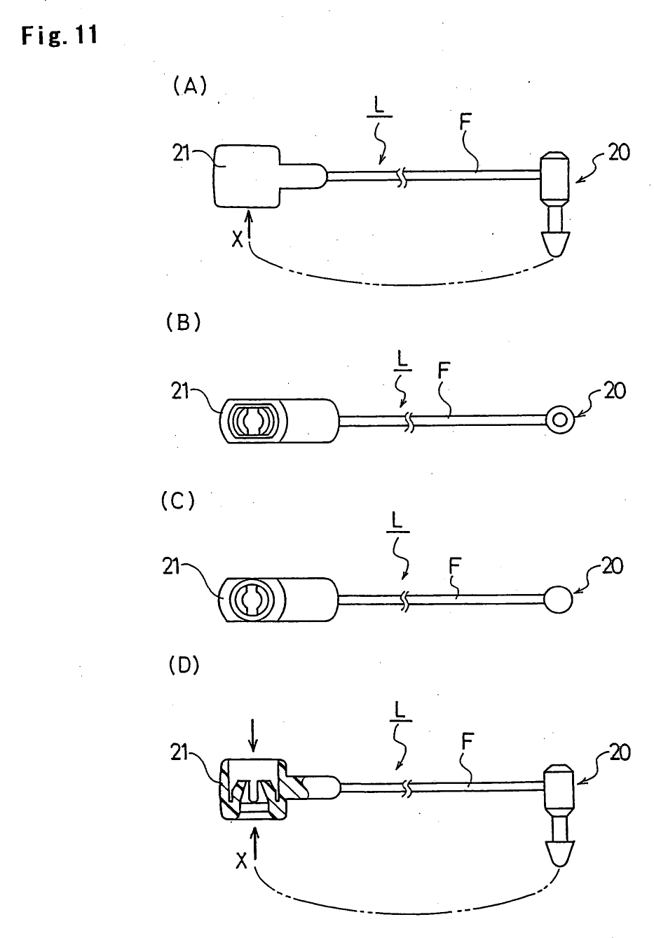

FIGS. 11(A) to 11(D) show modifications of the annular attaching tool L of display tag using the coated fiber F, in which FIGS. 11(A) and 11(B) show angular fitting holes formed on the engaging female portion 21 and FIGS. 11(C) and 11(D) show circular fitting holes formed on the engaging female portion 21. In the case of the attaching tool L of display tag of this example, the coated fiber F and the engaging male portion 20 are joined like a T shape. Moreover, in the case of FIG. 10(B), the engaging male portion 20 and the coated fiber F are linearly joined each other.

The difference of the bonding state between the engaging male portion 20 and the coated fiber F relates to the shape of a circular arc drawn by the coated fiber F when annularly engaging the attaching tool L of display tag. This is superior in the fact that illustrations shown in FIG. 10 have a larger bonding strength between the engaging male portion 20 and the coated fiber F.

### Third Embodiment: Aggregate of Attaching Tools of Display Tag or the Like

Then, the aggregate A of attaching tools of display tags or the like respectively using the coated fiber F having a built-in magnetic body for marker is described below.

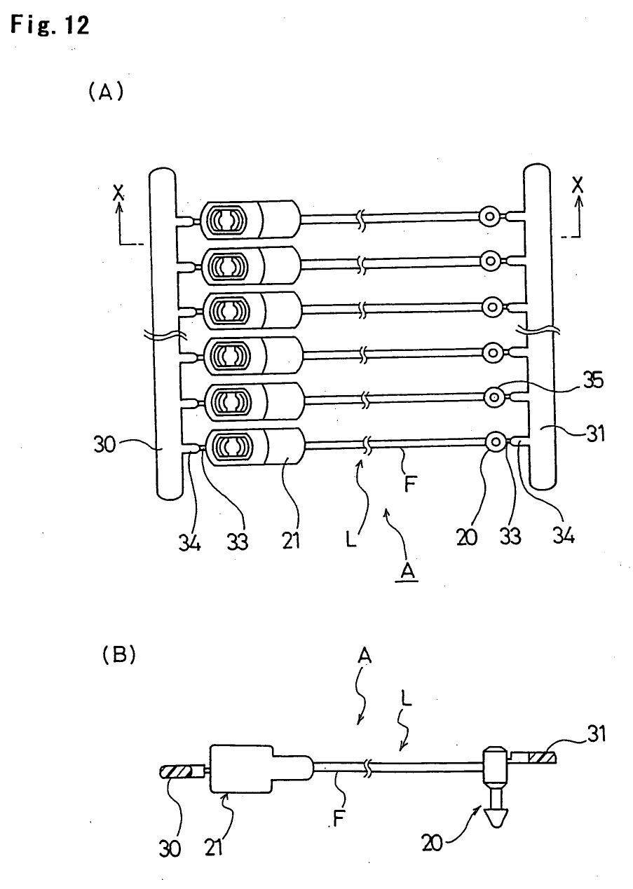

First, the flat-plate aggregate A of the attaching tools L of display tags or the like shown in FIG. 12 is constituted as a whole by orthogonally arranging many attaching tools L of display tags or the like in parallel between a flat-plate first connecting rod 30 and a flat-plate second connecting rod 31, and connecting the first connecting rod 30 with the engaging female portion 21 through a connecting portion 34 on which a thin-cross-sectional cutting portion 33 is formed so that the connecting portion 34 can be cut. Moreover, the aggregate A is constituted by connecting the engaging male portion 20 side by a connecting portion 34 on which a cutting portion 33 is formed and supporting many attaching tools L between two correcting rods 30 and 31 in parallel so that they can be cut.

When using the attaching tool aggregate A, the display tag Ds is set to the goods G by hammering out the attaching tools L by the publicly-known setting unit (for example, refer to Japanese patent application Kokai publication No. 1999-49125) and annularly connecting the attaching tools L as shown in FIG. 10(A). Because the above connecting operation can be made by one touch in accordance with the gripping operation of the lever of the setting unit, it is possible to quickly set the display tag Ds to the goods G.

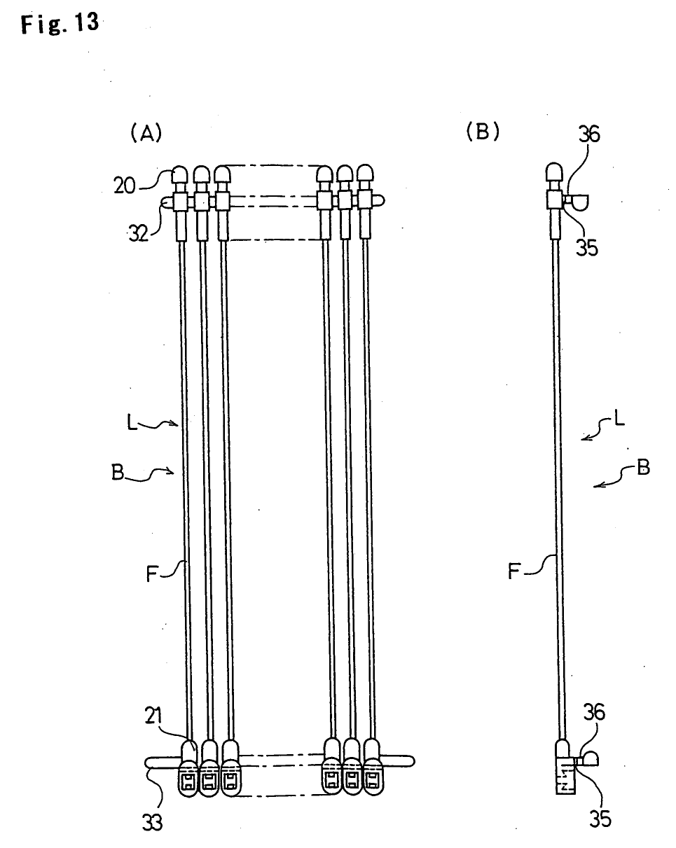

Moreover, FIGS. 13(A) and 13(B) show an aggregate B obtained by connecting the attaching tools L of display tags or the like respectively using the coated fiber F using a yarn-like body constituted by the soft magnetic fiber f serving as a magnetic body for marker as a core body like a flat plate, in which many attaching tools L of display tags or the like are arranged in parallel, connecting rods 32 and 33 are set like sleepers at the intermediate position between sides of the engaging male portion 20 and engaging female portion 21, and connecting rods 32 and 33 and the attaching tools L are connected at small intervals by a connecting portion 36 on which a cutting portion 35 is formed so that they can be cut.

As a result of comparing the aggregate A of attaching tools L of display tags or the like shown in FIG. 12 with the aggregate B shown in FIG. 13, both are different from each other in that the connecting rods 30 and 31 are arranged in the extension direction of the attaching tools L of display tags or the like in the case of the former but the connecting rods 32 and 33 are arranged like sleepers in the case of the latter. The means for removing each attaching tool L of a display tag or the like from the connecting rods 30, 31, 32, and 33 slightly depends on a setting unit, but this difference is not essential.

When using the configuration of the aggregate A of attaching tools L as shown in FIG. 12, it is possible to mount the engaging male portion 20 and the engaging female portion 21 to a gun-type setting unit while forming portions of the coated fibers F of the attaching tools L of display tags or the like arranged as sheet-like continuous bodies into U-shape and arranging them at the outside of the setting unit. Moreover, when sending the coated fibers F to the front-end side, it is possible to send them while forming them into U-shape and therefore, they are not tangled.

Furthermore, in the case of the aggregate A of attaching tools L shown in FIG. 12, it is possible to use a configuration in which the cutting portion 33 or connecting portion 34 is not set at the rear end of the engaging male portion 20. Therefore, it is possible to adopt a mechanism of pressing the rear end of the engaging male portion 20 by a thrusting rod which advances by a lever operation to discharge it from a hollow needle as a mechanism for discharging the engaging male portion 20 in a setting unit and it is possible to simplify the discharging mechanism.

As described above, the present invention uses the coated fiber F having the soft magnetic fiber f serving as a magnetic body for marker as a yarn-like connecting portion, in which a first member is set to one end of the connecting portion and a second member is set to the other end of the same.

When using the first member as the plate-like head portion h and the second member as the crossbar portion b, it is possible to use the attaching tool T of a display tag or the like as a “tag pin T”.

Moreover, when using the first member as an engaging male portion and the second member as an engaging female portion, it is possible to realize an “annular connecting tool (trade name: LOCKS)”.

Furthermore, the present invention has the following various advantages.

1. Because the soft magnetic fiber f forms the reinforcement material g of glass fiber or other fiber and moreover, the core material 1 constituted by a yarn-like body by arranging the soft magnetic fiber f and semi-hard magnetic fiber fh together, and forms the plastic coating layer p on the surface of the core material 1 to constitute the coated fiber F, the strength of the coated fiber F is increased.

Therefore, an attaching tool using the soft magnetic fiber f has a strength equal to or more than a normal attaching tool of a display tag or the like not using the soft magnetic fiber f.

Moreover, when an attaching tool is a tag pin, strengths of the crossbar portion b, the coated fiber F, and the connecting portion of the head portion h are increased. Thereby, an attaching tool is not removed even if the angle between the crossbar portion b and the coated fiber F is changed (by approx. 90° to 30°) when setting a display tag serving as a tag pin to goods by using a setting unit because the angle elastically recovers to the original right-angle state and the display tag can be quickly fixed to goods. Moreover, it is possible to set a display tag by the setting unit similarly to the case of a conventional attaching tool.

2. Because the attaching tool has a first member and a second member at its both ends by using the coated fiber F as a central member, the junction force between the first and the second members increases and it is possible to set a display tag by using a conventional setting unit.

3. Moreover, when using a resin same as the resin to be coated for the first and the second members, the appearance becomes completely the same as a conventional attaching tool of a tag pin or the like. Therefore, the presence or absence of a magnetic body for marker cannot be determined, and the concealing characteristic is extremely improved (security characteristic is improved).

4. Because the color of the coated fiber F can be changed for the first and the second members, it is possible to display the quality and application of goods.

5. Moreover, by using the coated fiber F having the magnetic body for marker as a component member of an attaching tool of a display tag such as a tap pin, it is possible to easily secure a sufficient length when the coated fiber F is detected in a sensing gate and generate a detection signal in a detection coil in the gate by easily magnetizing the coated fiber F in an alternate field that is generated in a magnetic burglarproof gate.

Moreover, the yarn-like, nylon-string-like, or bristle-like coated fiber F is the same as a normal yarn-like body in appearance and has a high concealing characteristic. Therefore, when setting a display tag to goods or the like by an attaching tool of a display tag or the like having the magnetic body for marker, there is no sense of incongruity and consumers cannot find the presence of a magnetic body for marker.

6. Because a yarn-like body using the soft magnetic fiber f as an indispensable component is protected by a plastic layer p (outer skin), it is possible to manufacture a superior attaching tool of a display tag or the like which is strong in dirt and elastic, and fancy.

### INDUSTRIAL APPLICABILITY

The present invention uses a coated fiber F having a soft magnetic fiber f serving as a magnetic body for marker as a yarn-like connecting portion, in which a first member is set to one end of the connecting portion and a second member is set to the other end of the same. Therefore, when using the first member as a plate-like head portion h and the second member as a crossbar portion b, it is possible to form an attaching tool of a display tag or the like as a “tag pin T”.

Moreover, when using the first member as an engaging male portion and the second member as an engaging female portion, it is possible to realize an “annular connecting tool” and set a merchandize tag such as a price tag superior in burglarproof characteristic of goods.

Furthermore, by using a coated fiber F having a soft magnetic fiber f, the present invention can be applied to various burglarproof units.

1. An attaching tool of a display tag or the like; wherein a soft magnetic fiber reacting on magnetism or a composite yarn consisting of the soft magnetic fiber and a fiber having a composition different from the soft magnetic fiber is used as a core yarn material, a coated fiber has a plastic outer skin formed on the circumference of the core yarn material, a first member is fixed to one end of the coated fiber, and a second member is fixed to the other end of the same.

2. The attaching tool of a display tag or the like wherein a composite yarn consisting of a soft magnetic fiber reacting on magnetism, a semi-hard magnetic fiber for inactivating a reaction on magnetism, and a reinforcement material is used as a core yarn material, a coated fiber is made by forming a plastic outer skin on the circumference of the core yarn material, and a first member fixed to one end of the coated fiber and a second member fixed to the other end of the same are fixed each other.

3. The attaching tool of a display tag or the like according to claim 1 or 2; wherein the first member is a thin-plate head portion, and the second member is a short crossbar portion.

4. The attaching tool of a display tag or the like according to claim 3; wherein the first member is a thin-plate head portion the second member is a short crossbar portion, and the core yarn material is extended in the crossbar portion.

5. The attaching tool of a display tag or the like according to claim 3; wherein the first member is a thin-plate head portion, the second member is a short crossbar portion, a filament is extended which directs from the center of the crossbar portion to the head portion, an expanded portion is formed on the filament portion, and the coated fiber extended from the head portion side is embedded in the expanded portion.

6. The attaching tool of a display tag or the like wherein a soft magnetic fiber reacting on magnetism or a composite yarn consisting of the soft magnetic fiber and a fiber having a composition different from the soft magnetic fiber is used as a core yarn material, a coated fiber is made by forming a plastic outer skin on the circumference of the core yarn material, a first member is fixed to one end of the coated fiber, a second member is fixed to the other end of the same, the first member is formed into an engaging male portion, the second member is formed into an engaging female portion in which an insertion hole is opened, and the engaging male portion is inserted into the insertion hole of the engaging female portion so that the male portion can be engaged like a ring so as not to be removed.

7. An aggregate of attaching tools of display tag arranged in parallel a plurality of attaching tools of display tags or the like, by using a soft magnetic fiber reacting on magnetism or a composite yarn consisting of the soft magnetic fiber and a fiber having a composition different from the soft magnetic fiber as a core yarn material, including a coated fiber made by forming a plastic outer skin on the circumference of the core yarn material, fixing a first member to one end of the coated fiber and a second member to the other end of the same respectively, providing with an engaging male portion as the first member and an engaging female portion in which an insertion hole is opened as the second member, inserting the engaging male portion into the insertion hole of the engaging female portion so that the engaging male portion can be engaged like a ring so as not to be removed; wherein the aggregate of attaching tools of display tags is formed into one flat plate as a whole, by connecting the attaching tools of display tags to one connecting rod disposed in the vicinity of the engaging male portion through a connecting portion which is able to be able to be cut, and further by connecting the attaching tools of display tags to one connecting rod disposed in the vicinity of the engaging female portion to be cut.

8. An aggregate of attaching tools of display tags arranged in parallel a plurality of attaching tools of display tags or the like, by using a soft magnetic fiber reacting on magnetism or a composite yarn consisting of the soft magnetic fiber and a fiber having a composition different from the soft magnetic fiber as a core yarn material, including a coated fiber made by forming a plastic outer skin on the circumference of the core yarn material, fixing a first member to one end of the coated fiber and a second member to the other end of the same respectively, providing with an engaging male portion as the first member and an engaging female portion in which an insertion hole is opened as the second member, inserting the engaging male portion into the insertion hole of the engaging female portion so that the engaging male portion can be engaged like a ring so as not to be removed; wherein the aggregate of attaching tools of display tags is formed into one flat plate as a whole, by connecting the attaching tools of display tags to one connecting rod through a connecting member which can be cut so as to support the engaging male portion in a state of sleepers to space toward the engaging male portion, and moreover by connecting the attaching tools of display tags to one connecting rod through a connecting member which can be cut so as to support the engaging female portion to space toward the engaging female portion.
